(19) United States
(12) Patent Application Publication
(10) Pub. No.: US 2007/0071073 A1
(43) Pub. Date: Mar. 29, 2007

(54) METHOD AND APPARATUS FOR INTERFERENCE CANCELLATION

(75) Inventor: Shu Wang, San Diego, CA (US)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/535,442

(22) Filed: Sep. 26, 2006

Related U.S. Application Data
(60) Provisional application No. 60/720,916, filed on Sep. 26, 2005.

(51) Int. Cl. H04B 1/00

(52) U.S. Cl. 375/148

(57) ABSTRACT

A method of mitigating interference in a wireless communication system is disclosed. More specifically, the method comprises receiving at least two signals from a plurality of transmitting ends, estimating interference value based on a predetermined number of the received signals and a current signal, removing interference from the received signals using the estimated interference value, and obtaining desired information from the interference-removed received signal.

This application claims the benefit of U.S. Provisional Application No. 60/720,916 filed on Sep. 26, 2005, which is hereby incorporated by reference.

### BACKGROUND OF THE INVENTION

1. Field of the Invention

The present invention relates to mitigating interference in transmission, and more particularly, to a method and apparatus for interference cancellation. Although the present invention is suitable for a wide scope of applications, it is particularly suitable for mitigating various interference, solving near-far problems, and enhancing communication system capacity.

2. Discussion of the Related Art

In the world of cellular telecommunications, those skilled in the art often use the terms 1G, 2G, and 3G. The terms refer to the generation of the cellular technology used. 1G refers to the first generation, 2G to the second generation, and 3G to the third generation.

1G refers to the analog phone system, known as an AMPS (Advanced Mobile Phone Service) phone systems. 2G is commonly used to refer to the digital cellular systems that are prevalent throughout the world, and include CDMAOne, Global System for Mobile communications (GSM), and Time Division Multiple Access (TDMA). 2G systems can support a greater number of users in a dense area than can 1G systems.

3G commonly refers to the digital cellular systems currently being deployed. These 3G communication systems are conceptually similar to each other with some significant differences.

One of a major goal of wireless cellular communication is reliable transmission of information at the highest possible data rates. To this end, two major obstacles or interference in communication channel include inter symbol interference (ISI) and co-channel interference (CCI). The ISI refers to the effect of neighboring symbols on the current symbol. Moreover, the CCI refers to the effect of symbols sent by other users int eh same channel on the symbols sent by the current user.

Unless the ISI and the CCI, if exists, are handled properly, they can lead to high bit error rates (BER) in the recover of the transmitted sequence at the receiver. Consequently, various methods have been and still are being developed to reduce the effects of the ISI and the CCI thus increasing the wireless communication system's performance.

Linear equalization (LE) and decision feedback equalization (DFE) are attempts in this direction. By exploiting the structure, including phase, amplitude, and possible statistics, of the channel, signals, and noise, the LE and the DFE may work well when there is only one major received signal or one major transmitter in the channel. They are known to be inefficient or to perform poorly when there is (are) other signal(s) received from different resources.

With advancement of orthogonal spreading sequences which are time-varying due to the embedded scrambling code used by wideband code division multiple access (WCDMA), these time-varying spreading sequences cause problems when applying multi-user detection (e.g., symbol-level minimum mean-squared error (MMSE) multi-user equalization) because the receiver filter has to be recalculated at each symbol interval and explicitly or implicitly track the channels or signal signatures from other users or signal resources.

To combat this requirement, a linear MMSE channel equalization with finite impulse response (FIR) filters at chip level on the CDMA downlink followed by a simple correlation with the spreading sequence of the desired user can be implemented. With this, complexity can be significantly reduced because the receiver filter performing linear channel equalization only has to be recalculated when the channel has changed noticeably.

Alternatively, a maximum likelihood sequence estimation (MLSE) can be used. The MLSE uses the Viterbi algorithm (VA) for equalization of frequency-selective channels producing ISI. However, the complexity of the VA becomes very high for long channel impulse responses (CIRs), and suboptimum schemes (e.g., DFE) has to be applied.

This means, in addition to MMSE linear channel equalization, a reasonable choice for a receiver algorithm when considering complexity is also MMSE-DFE. To overcome the problems from the time-varying nature of the spreading sequences, this algorithm also has to be applied at chip level. But due to the spreading with a factor N, new feedback chips are only available discontinuously when a CDMA symbol is received completely (i.e., each N chip). This problem can be solved by detecting a block

### SUMMARY OF THE INVENTION

Accordingly, the present invention is directed to a method and apparatus for interference cancellation that substantially obviates one or more problems due to limitations and disadvantages of the related art.

An object of the present invention is to provide a method of mitigating interference in a wireless communication system.

Another object of the present invention is to provide a receiver system for mitigating interference.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of mitigating interference in a wireless communication system includes receiving at least two signals from a plurality of transmitting ends, estimating interference value based on a predetermined number of the received signals and a current signal, removing interference from the received signals using the estimated interference value, and obtaining desired information from the interference-removed received signal.

In another aspect of the present invention, a wireless communication system for mitigating interference includes a noise whitening unit for converting noise of at least one received signal to a white noise, a feedback filtering unit for estimating interference value based on a predetermined number of the received signals and a current signal, a removing unit for removing interference of a received signal using the estimated interference value, and acquisition unit for obtaining desired information from the interference-removed received signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates wireless communication network architecture;

FIG. 2A illustrates a CDMA spreading and de-spreading process;

FIG. 2B illustrates a CDMA spreading and de-spreading process using multiple spreading sequences;

FIG. 3 illustrates a data link protocol architecture layer for a cdma2000 wireless network;

FIG. 4 illustrates cdma2000 call processing;

FIG. 5 illustrates the cdma2000 initialization state;

FIG. 6 illustrates the cdma2000 system access state;

FIG. 7 illustrates a conventional cdma2000 access attempt;

FIG. 8 illustrates a conventional cdma2000 access sub-attempt;

FIG. 9 illustrates the conventional cdma2000 system access state using slot offset;

FIG. 10 illustrates a comparison of cdma2000 for 1x and 1xEV-DO;

FIG. 11 illustrates a network architecture layer for a 1xEV-DO wireless network;

FIG. 12 illustrates 1xEV-DO default protocol architecture;

FIG. 13 illustrates 1xEV-DO non-default protocol architecture;

FIG. 14 illustrates 1xEV-DO session establishment;

FIG. 15 illustrates 1xEV-DO connection layer protocols;

FIG. 16 illustrates a flow diagram of a decision feedback interference cancellation process; and

FIG. 17 is an exemplary diagram illustrating decision feedback interference cancellation.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

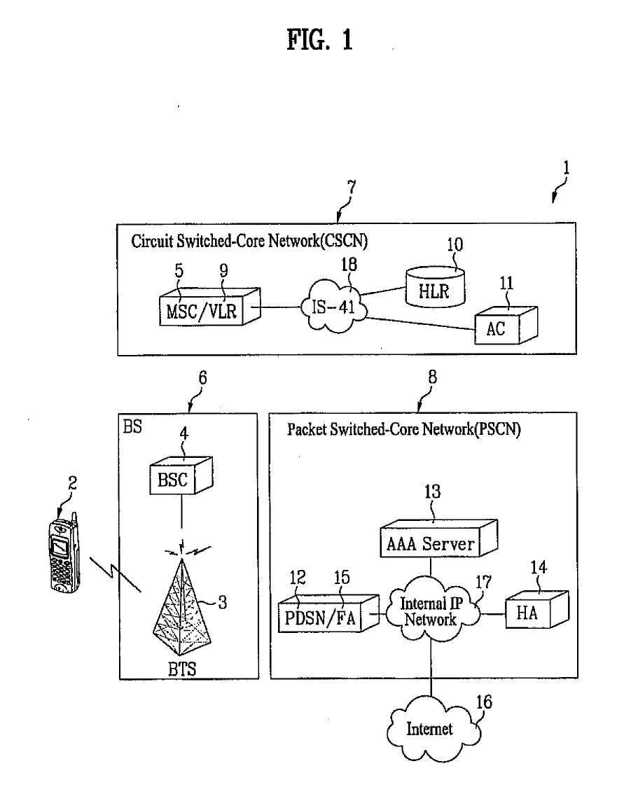

Referring to FIG. 1, a wireless communication network architecture1 is illustrated. A subscriber uses a mobile station (MS) 2 to access network services. The MS 2 may be a portable communications unit, such as a hand-held cellular phone, a communication unit installed in a vehicle, or a fixed-location communications unit.

The electromagnetic waves for the MS 2 are transmitted by the Base Transceiver System (BTS) 3 also known as node B. The BTS 3 consists of radio devices such as antennas and equipment for transmitting and receiving radio waves. The BS 6 Controller (BSC) 4 receives the transmissions from one or more BTS's. The BSC 4 provides control and management of the radio transmissions from each BTS 3 by exchanging messages with the BTS and the Mobile Switching Center USC) 5 or Internal IP Network. The BTS's 3 and BSC 4 are part of the BS 6 (BS) 6.

The BS 6 exchanges messages with and transmits data to a Circuit Switched Core Network (CSCN) 7 and Packet Switched Core Network (PSCN) 8. The CSCN 7 provides traditional voice communications and the PSCN 8 provides Internet applications and multimedia services.

The Mobile Switching Center (MSC) 5 portion of the CSCN 7 provides switching for traditional voice communications to and from a MS 2 and may store information to support these capabilities. The MSC 2 may be connected to one of more BS's 6 as well as other public networks, for example a Public Switched Telephone Network (PSTN) (not shown) or Integrated Services Digital Network (ISDN) (not shown). A Visitor Location Register (VLR) 9 is used to retrieve information for handling voice communications to or from a visiting subscriber. The VLR 9 may be within the MSC 5 and may serve more than one MSC.

A user identity is assigned to the Home Location Register (HLR) 10 of the CSCN 7 for record purposes such as subscriber information, for example Electronic Serial Number (ESN), Mobile Directory Number (MDR), Profile Information, Current Location, and Authentication Period. The Authentication Center (AC) 11 manages authentication information related to the MS 2. The AC 11 may be within the HLR 10 and may serve more than one HLR. The interface between the MSC 5 and the HLR/AC 10, 11 is an IS-41 standard interface 18.

The Packet data Serving Node (PDSN) 12 portion of the PSCN 8 provides routing for packet data traffic to and from MS 2. The PDSN 12 establishes, maintains, and terminates link layer sessions to the MS 2's 2 and may interface with one of more BS 6 and one of more PSCN 8.

The Authentication, Authorization and Accounting (AAA) 13 Server provides Internet Protocol authentication, authorization and accounting functions related to packet data traffic. The Home Agent (HA) 14 provides authentication of MS 2 IP registrations, redirects packet data to and from the Foreign Agent (FA) 15 component of the PDSN 8, and receives provisioning information for users from the AAA 13. The HA 14 may also establish, maintain, and terminate secure communications to the PDSN 12 and assign a dynamic IP address. The PDSN 12 communicates with the AAA 13, HA 14 and the Internet 16 via an Internal IP Network.

There are several types of multiple access schemes, specifically Frequency Division Multiple Access (FDMA), Time Division Multiple Access (TDMA) and Code Division Multiple Access (CDMA). In FDMA, user communications are separated by frequency, for example, by using 30 KHz channels. In TDMA, user communications are separated by frequency and time, for example, by using 30 KHz channels with 6 timeslots. In CDMA, user communications are separated by digital code.

In CDMA, All users on the same spectrum, for example, 1.25 MHz. Each user has a unique digital code identifier and the digital codes separate users to prevent interference.

A CDMA signal uses many chips to convey a single bit of information. Each user has a unique chip pattern, which is essentially a code channel. In order to recover a bit, a large number of chips are integrated according to a user's known chip pattern. Other user's code patterns appear random and are integrated in a self-canceling manner and, therefore, do not disturb the bit decoding decisions made according to the user's proper code pattern.

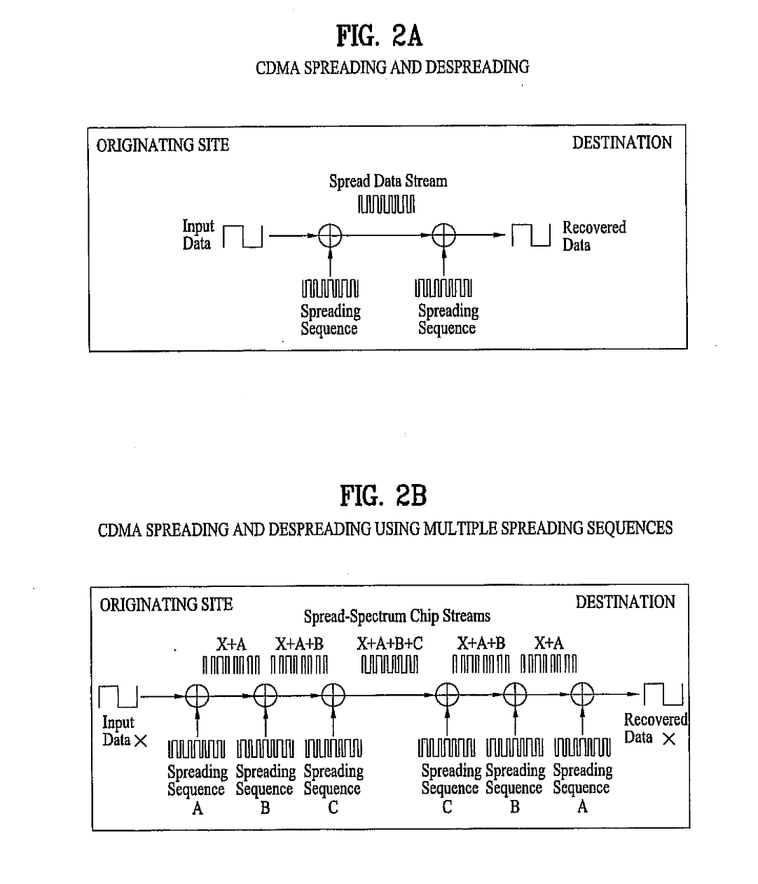

Input data is combined with a fast spreading sequence and transmitted as a spread data stream. A receiver uses the same spreading sequence to extract the original data. FIG. 2A illustrates the spreading and de-spreading process. As illustrated in FIG. 2B, multiple spreading sequences may be combined to create unique, robust channels.

A Walsh code is one type of spreading sequence. Each Walsh code is 64 chips long and is precisely orthogonal to all other Walsh codes. The codes are simple to generate and small enough to be stored in read only memory (ROM).

A short PN code is another type of spreading sequence. A short PN code consists of two PN sequences (I and Q), each of which is 32,768 chips long and is generated in similar, but differently tapped 15-bit shift registers. The two sequences scramble the information on the I and Q phase channels.

A long PN code is another type of spreading sequence. A long PN code is generated in a 42-bit register and is more than 40 days long, or about 4×10¹³ chips long. Due to its length, a long PN code cannot be stored in ROM in a terminal and, therefore, is generated chip-by-chip.

Each MS 2 codes its signal with the PN long code and a unique offset, or public long code mask, computed using the long PN code ESN of 32-bits and 10 bits set by the system. The public long code mask produces a unique shift. Private long code masks may be used to enhance privacy. When integrated over as short a period as 64 chips, MS 2 with different long PN code offsets will appear practically orthogonal.

CDMA communication uses forward channels and reverse channels. A forward channel is utilized for signals from a BTS 3 to a MS 2 and a reverse channel is utilized for signals from a MS to a BTS.

A forward channel uses its specific assigned Walsh code and a specific PN offset for a sector, with one user able to have multiple channel types at the same time. A forward channel is identified by its CDMA RF carrier frequency, the unique short code PN offset of the sector and the unique Walsh code of the user. CDMA forward channels include a pilot channel, sync channel, paging channels and traffic channels.

The pilot channel is a “structural beacon” which does not contain a character stream, but rather is a timing sequence used for system acquisition and as a measurement device during handoffs. A pilot channel uses Walsh code 0.

The sync channel carries a data stream of system identification and parameter information used by MS 2 during system acquisition. A sync channel uses Walsh code 32.

There may be from one to seven paging channels according to capacity requirements. Paging channels carry pages, system parameter information and call setup orders. Paging channels use Walsh codes 1-7.

The traffic channels are assigned to individual users to carry call traffic. Traffic channels use any remaining Walsh codes subject to overall capacity as limited by noise.

A reverse channel is utilized for signals from a MS 2 to a BTS 3 and uses a Walsh code and offset of the long PN sequence specific to the MS, with one user able to transmit multiple types of channels simultaneously. A reverse channel is identified by its CDMA RF carrier frequency and the unique long code PN Offset of the individual MS 2. Reverse channels include traffic channels and access channels.

Individual users use traffic channels during actual calls to transmit traffic to the BTS 3. A reverse traffic channel is basically a user-specific public or private long code Mask and there are as many reverse traffic channels as there are CDMA terminals.

An MS 2 not yet involved in a call uses access channels to transmit registration requests, call setup requests, page responses, order responses and other signaling information. An access channel is basically a public long code offset unique to a BTS 3 sector. Access channels are paired with paging channels, with each paging channel having up to 32 access channels.

CDMA communication provides many advantages. Some of the advantages are variable rate vocoding and multiplexing, power control, use of RAKE receivers and soft handoff.

CDMA allows the use of variable rate vocoders to compress speech, reduce bit rate and greatly increase capacity. Variable rate vocoding provides full bit rate during speech, low data rates during speech pauses, increased capacity and natural sound. Multiplexing allows voice, signaling and user secondary data to be mixed in CDMA frames,

By utilizing forward power control, the BTS 3 continually reduces the strength of each user's forward baseband chip stream. When a particular MS 2 experiences errors on the forward link, more energy is requested and a quick boost of energy is supplied after which the energy is again reduced.

Using a RAKE receiver allows a MS 2 to use the combined outputs of the three traffic correlators, or “RAKE fingers,” every frame. Each RAKE finger can independently recover a particular PN Offset and Walsh code. The fingers may be targeted on delayed multipath reflections of different BTS's 3, with a searcher continuously checking pilot signals.

The MS 2 drives soft handoff The MS 2 continuously checks available pilot signals and reports to the BTS 3 regarding the pilot signals it currently sees. The BTS 3 assigns up to a maximum of six sectors and the MS 2 assigns its fingers accordingly. Al messages are sent by dim-and-burst without muting. Each end of the communication link chooses the best configuration on a frame-by-frame basis, with handoff transparent to users.

A cdma2000 system is a third-generation (3G) wideband; spread spectrum radio interface system that uses the enhanced service potential of CDMA technology to facilitate data capabilities, such as Internet and intranet access, multimedia applications, high-speed business transactions, and telemetry. The focus of cdma2000, as is that of other third-generation systems, is on network economy and radio transmission design to overcome the limitations of a finite amount of radio spectrum availability.

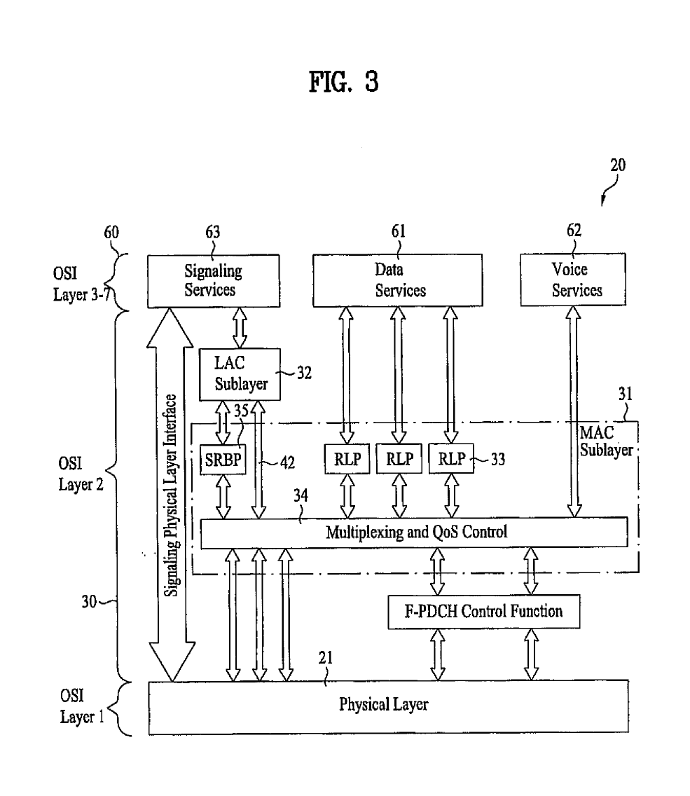

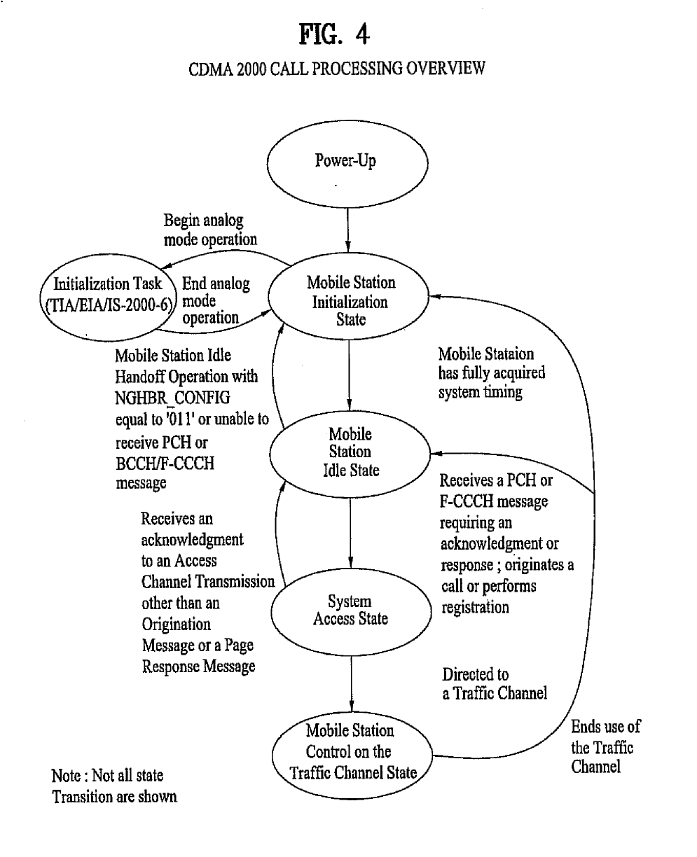

FIG. 3 illustrates a data link protocol architecture layer 20 for a cdma2000 wireless network. The data link protocol architecture layer 20 includes an Upper Layer 60, a Link Layer 30 and a Physical layer 21.

The Upper layer 60 includes three sublayers; a Data Services sublayer 61; a Voice Services sublayer 62 and a Signaling Services sublayer 63. Data services 61 are services that deliver any form of data on behalf of a mobile end user and include packet data applications such as IP service, circuit data applications such as asynchronous fax and B-ISDN emulation services, and SMS. Voice services 62 include PSTN access, mobile-to-mobile voice services, and Internet telephony. Signaling 63 controls all aspects of mobile operation.

The Signaling Services sublayer 63 processes all messages exchanged between the MS 2 and BS 6. These messages control such functions as call setup and teardown, handoffs, feature activation, system configuration, registration and authentication.

The Link Layer 30 is subdivided into the Link Access Control (LAC) sublayer 32 and the Medium Access Control (MAC) sublayer 31. The Link Layer 30 provides protocol support and control mechanisms for data transport services and performs the functions necessary to map the data transport needs of the Upper layer 60 into specific capabilities and characteristics of the Physical Layer 21. The Link Layer 30 may be viewed as an interface between the Upper Layer 60 and the Physical Layer 20.

The separation of MAC 31 and LAC 32 sublayers is motivated by the need to support a wide range of Upper Layer 60 services and the requirement to provide for high efficiency and low latency data services over a wide performance range, specifically from 1.2 Kbps to greater than 2 Mbps. Other motivators are the need for supporting high Quality of Service (QoS) delivery of circuit and packet data services, such as limitations on acceptable delays and/or data BER (bit error rate), and the growing demand for advanced multimedia services each service having a different QoS requirements.

The LAC sublayer 32 is required to provide a reliable, in-sequence delivery transmission control function over a point-to-point radio transmission link 42. The LAC sublayer 32 manages point-to point communication channels between upper layer 60 entities and provides framework to support a wide range of different end-to-end reliable Link Layer 30 protocols.

The Link Access Control (LAC) sublayer 32 provides correct delivery of signaling messages. Functions include assured delivery where acknowledgement is required, unassured delivery where no acknowledgement is required, duplicate message detection, address control to deliver a message to an individual MS 2, segmentation of messages into suitable sized fragments for transfer over the physical medium, reassembly and validation of received messages and global challenge authentication.

The MAC sublayer 31 facilitates complex multimedia, multi-services capabilities of 3G wireless systems with QoS management capabilities for each active service. The MAC sublayer 31 provides procedures for controlling the access of packet data and circuit data services to the Physical Layer 21, including the contention control between multiple services from a single user, as well as between competing users in the wireless system. The MAC sublayer 31 also performs mapping between logical channels and physical channels, multiplexes data from multiple sources onto single physical channels and provides for reasonably reliable transmission over the Radio Link Layer using a Radio Link Protocol (RLP) 33 for a best-effort level of reliability. Signaling Radio Burst Protocol (SRBP) 35 is an entity that provides connectionless protocol for signaling messages. Multiplexing and QoS Control 34 is responsible for enforcement of negotiated QoS levels by mediating conflicting requests from competing services and the appropriate prioritization of access requests.

The Physical Layer 20 is responsible for coding and modulation of data transmitted over the air. The Physical Layer 20 conditions digital data from the higher layers so that the data may be transmitted over a mobile radio channel reliably.

The Physical Layer 20 maps user data and signaling, which the MAC sublayer 31 delivers over multiple transport channels, into a physical channels and transmits the information over the radio interface. In the transmit direction, the functions performed by the Physical Layer 20 include channel coding, interleaving, scrambling, spreading and modulation. In the receive direction, the functions are reversed in order to recover the transmitted data at the receiver.

FIG. 4 illustrates an overview of call processing. Processing a call includes pilot and sync channel processing, paging channel processing, access channel processing and traffic channel processing.

Pilot and sync channel processing refers to the MS 2 processing the pilot and sync channels to acquire and synchronize with the CDMA system in the MS 2 Initialization State. Paging channel processing refers to the MS 2 monitoring the paging channel or the forward common control channel (F-CCCH) to receive overhead and mobile-directed messages from the BS 6 in the Idle State. Access channel processing refers to the MS 2 sending messages to the BS 6 on the access channel or the Enhanced access channel in the System Access State, with the BS 6 always listening to these channels and responding to the MS on either a paging channel or the F-CCCH. Traffic channel processing refers to the BS 6 and MS 2 communicating using dedicated forward and reverse traffic channels in the MS 2 Control on Traffic Channel State, with the dedicated forward and reverse traffic channels carrying user information, such as voice and data.

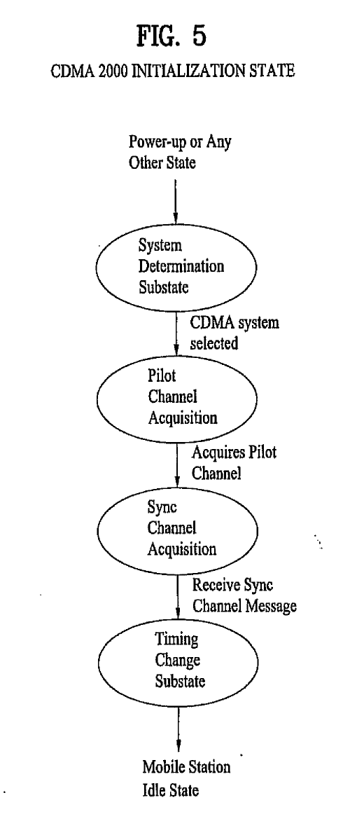

FIG. 5 illustrates the initialization state of a MS 2. The Initialization state includes a System Determination Substate, Pilot Channel Acquisition, Sync Channel Acquisition, a Timing Change Substate and a Mobile Station Idle State.

System Determination is a process by which the MS 2 decides from which system to obtain service. The process could include decisions such as analog versus digital, cellular versus PCS, and A carrier versus B carrier. A custom selection process may control System Determination. A service provider using a redirection process may also control System determination. After the MS 2 selects a system, it must determine on which channel within that system to search for service. Generally the MS 2 uses a prioritized channel list to select the channel.

Pilot Channel Processing is a process whereby the MS 2 first gains information regarding system timing by searching for usable pilot signals. Pilot channels contain no information, but the MS 2 can align its own timing by correlating with the pilot channel. Once this correlation is completed, the MS 2 is synchronized with the sync channel and can read a sync channel message to further refine its timing. The MS 2 is permitted to search up to 15 seconds on a single pilot channel before it declares failure and returns to System determination to select either another channel or another system. The searching procedure is not standardized, with the time to acquire the system depending on implementation.

In cdma2000, there may be many pilot channels, such as OTD pilot, STS pilot and Auxiliary pilot, on a single channel. During System Acquisition, the MS 2 will not find any of these pilot channels because they are use different Walsh codes and the MS is only searching for Walsh 0.

The sync channel message is continuously transmitted on the sync channel and provides the MS 2 with the information to refine timing and read a paging channel. The mobile receives information from the BS 6 in the sync channel message that allows it to determine whether or not it will be able to communicate with that BS.

In the Idle State, the MS 2 receives one of the paging channels and processes the messages on that channel. Overhead or configuration messages are compared to store sequence numbers to ensure the MS 2 has the most current parameters. Messages to the MS 2 are checked to determine the intended subscriber.

The BS 6 may support multiple paging channels and/or multiple CDMA channel (frequencies). The MS 2 uses a hash function based on its IMSI to determine which channel and frequency to monitor in the Idle State. The BS 6 uses the same hash function to determine which channel and frequency to use when paging the MS 2.

Using a Slot Cycle Index (SCI) on the paging channel and on F-CCCH supports slotted paging. The main purpose of slotted paging is to conserve battery power in MS 2. Both the MS 2 and BS 6 agree in which slots the MS will be paged. The MS 2 can power down some of its processing circuitry during unassigned slots. Either the General Page message or the Universal Page message may be used to page the mobile on F-CCCH. A Quick paging channel that allows the MS 2 to power up for a shorter period of time than is possible using only slotted paging on F-PCH or F-CCCH is also supported.

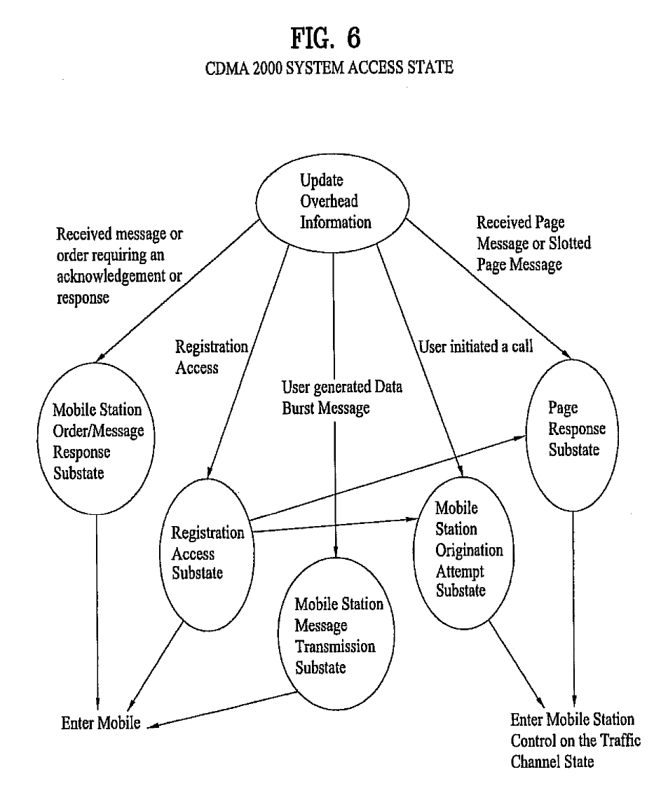

FIG. 6 illustrates the System Access state. The first step in the system access process is to update overhead information to ensure that the MS 2 is using the correct access channel parameters, such as initial power level and power step increments. A MS 2 randomly selects an access channel and transmits without coordination with the BS 6 or other MS. Such a random access procedure can result in collisions. Several steps can be taken to reduce the likelihood of collision, such as use of a slotted structure, use of a multiple access channel, transmitting at random start times and employing congestion control, for example, overload classes,

The MS 2 may send either a request or a response message on the access channel. A request is a message sent autonomously, such as an Origination message. A response is a message sent in response to a message received from the BS 6. For example, a Page Response message is a response to a General Page message or a Universal message.

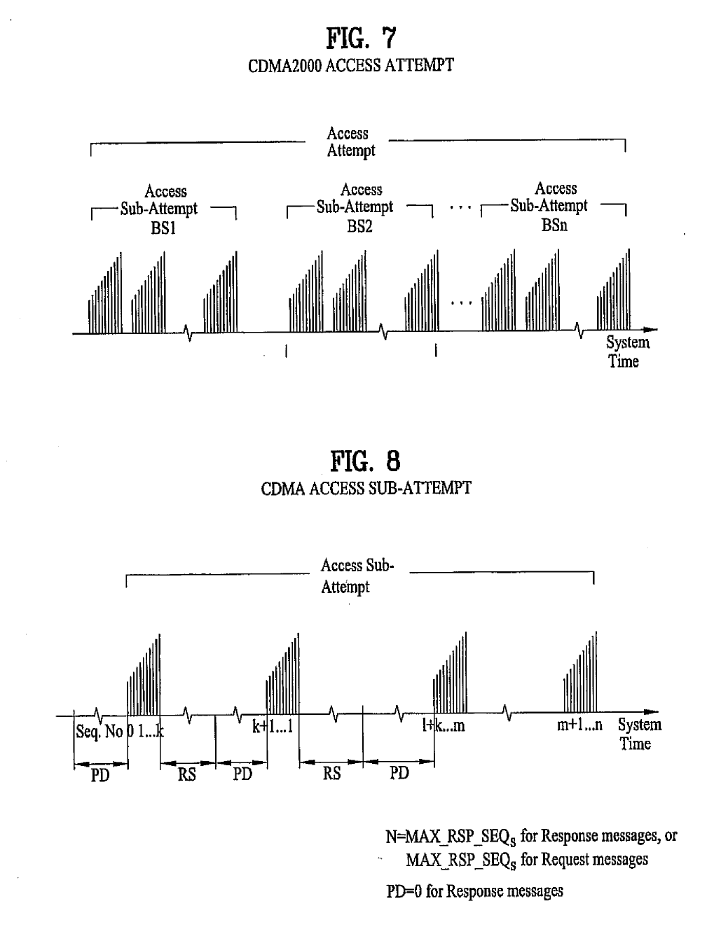

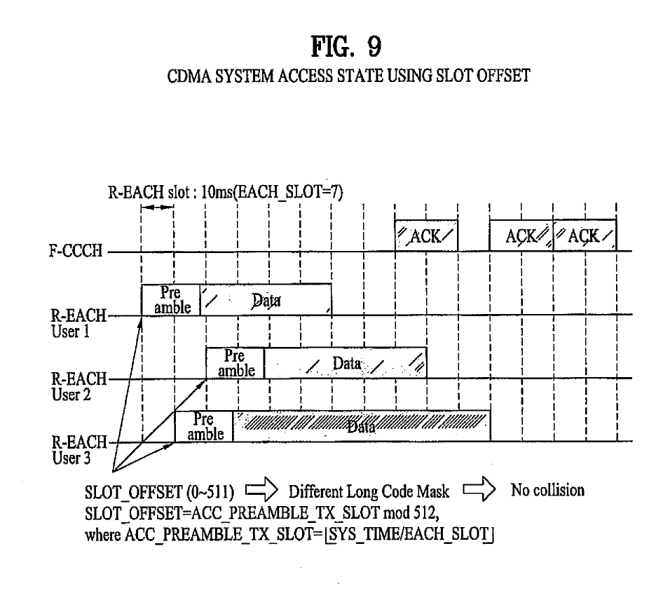

An access attempt, which refers to the entire process of sending one Layer 2 encapsulated PDU and receiving an acknowledgment for the PDU, consists of one or more access sub-attempts, as illustrated in FIG. 7. An access sub-attempt includes of a collection of access probe sequences, as illustrated in FIG. 8. Sequences within an access sub-attempt are separated by a random backoff interval (RS) and a persistence delay (PD). PD only applies to access channel request, not response. FIG. 9 illustrates a System Access state in which collisions are avoided by using a slot offset of 0-511 slots.

The Multiplexing and QoS Control sublayer 34 has both a transmitting function and a receiving function. The transmitting function combines information from various sources, such as Data Services 61, Signaling Services 63 or Voice Services 62, and forms Physical layer SDUs and PDCHCF SDUs for transmission. The receiving function separates the information contained in Physical Layer 21 and PDCHCF SDUs and directs the information to the correct entity, such as Data Services 61, Upper Layer Signaling 63 or Voice Services 62.

The Multiplexing and QoS Control sublayer 34 operates in time synchronization with the Physical Layer 21. If the Physical Layer 21 is transmitting with a non-zero frame offset, the Multiplexing and QoS Control sublayer 34 delivers Physical Layer SDUs for transmission by the Physical Layer at the appropriate frame offset from system time.

The Multiplexing and QoS Control sublayer 34 delivers a Physical Layer 21 SDU to the Physical Layer using a physical-channel specific service interface set of primitives. The Physical Layer 21 delivers a Physical Layer SDU to the Multiplexing and QoS Control sublayer 34 using a physical channel specific Receive Indication service interface operation.

The SRBP Sublayer 35 includes the sync channel, forward common control channel, broadcast control channel, paging channel and access channel procedures.

The LAC Sublayer 32 provides services to Layer 3 60. SDUs are passed between Layer 3 60 and the LAC Sublayer 32. The LAC Sublayer 32 provides the proper encapsulation of the SDUs into LAC PDUs, which are subject to segmentation and reassembly and are transferred as encapsulated PDU fragments to the MAC Sublayer 31.

Processing within the LAC Sublayer 32 is done sequentially, with processing entities passing the partially formed LAC PDU to each other in a well-established order. SDUs and PDUs are processed and transferred along functional paths, without the need for the upper layers to be aware of the radio characteristics of the physical channels. However, the upper layers could be aware of the characteristics of the physical channels and may direct Layer 2 30 to use certain physical channels for the transmission of certain PDUs.

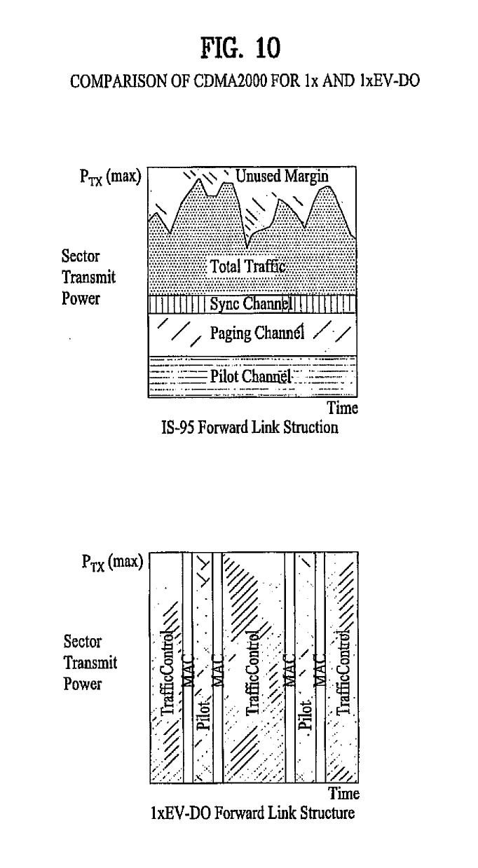

A 1xEV-DO system is optimized for packet data service and characterized by a single 1.25 MHz carrier (“1x”) for data only or data Optimized (“DO”). Furthermore, there is a peak data rate of 2.4 Mbps or 3.072 Mbps on the forward Link and 153.6 Kbps or 1.8432 Mbps on the reverse Link. Moreover, a 1xEV-DO system provides separated frequency bands and internetworking with a 1x System. FIG. 10 illustrates a comparison of cdma2000 for a 1x system and a 1xEV-DO system.

In CDMA2000, there are concurrent services, whereby voice and data are transmitted together at a maximum data rate of 614.4 kbps and 307.2 kbps in practice. An MS 2 communicates with the MSC 5 for voice calls and with the PDSN 12 for data calls. A cdma2000 system is characterized by a fixed rate with variable power with a Walsh-code separated forward traffic channel.

In a 1xEV-DO system, the maximum data rate is 2.4 Mbps or 3.072 Mbps and there is no communication with the circuit-switched core network 7. A 1xEV-DO system is characterized by fixed power and a variable rate with a single forward channel that is time division multiplexed.

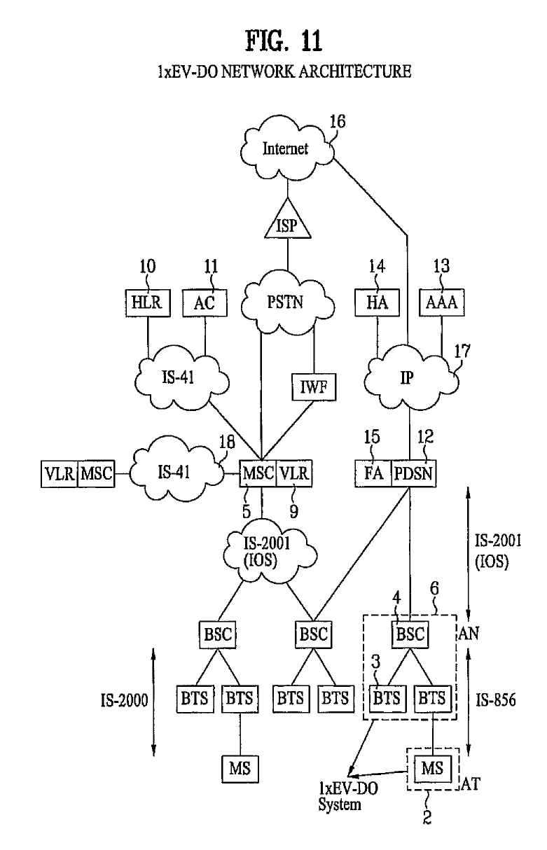

FIG. 11 illustrates a 1xEV-DO system architecture. In a 1xEV-DO system, a frame consists of 16 slots, with 600 slots/sec, and has a duration of 26.67 ms, or 32,768 chips, A single slot is 1.6667 ms long and has 2048 chips. A control/traffic channel has 1600 chips in a slot, a pilot channel has 192 chips in a slot and a MAC channel has 256 chips in a slot. A 1xEV-DO system facilitates simpler and faster channel estimation and time synchronization,

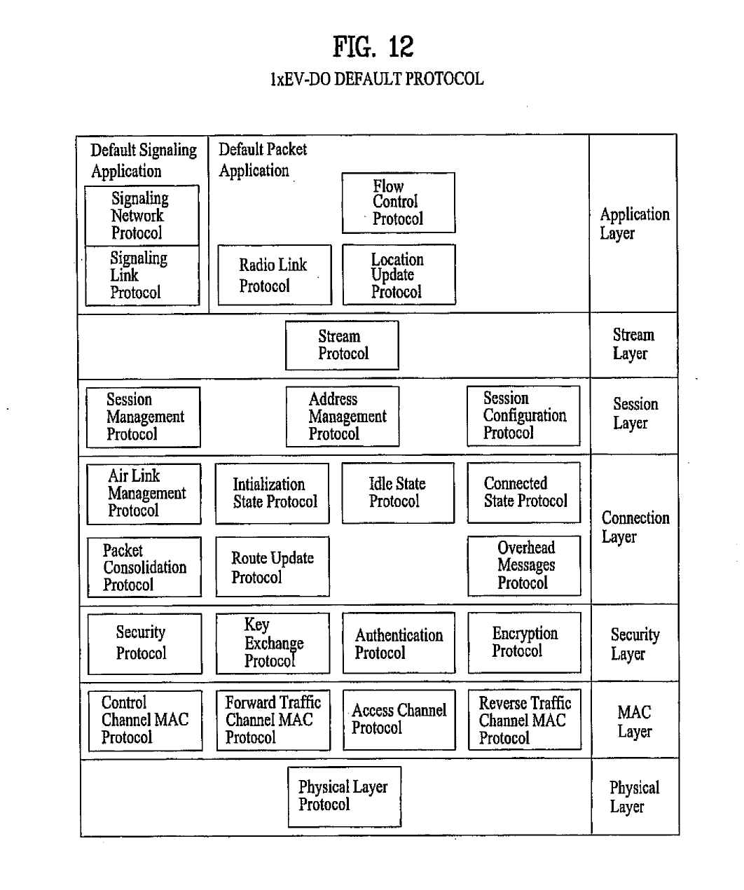

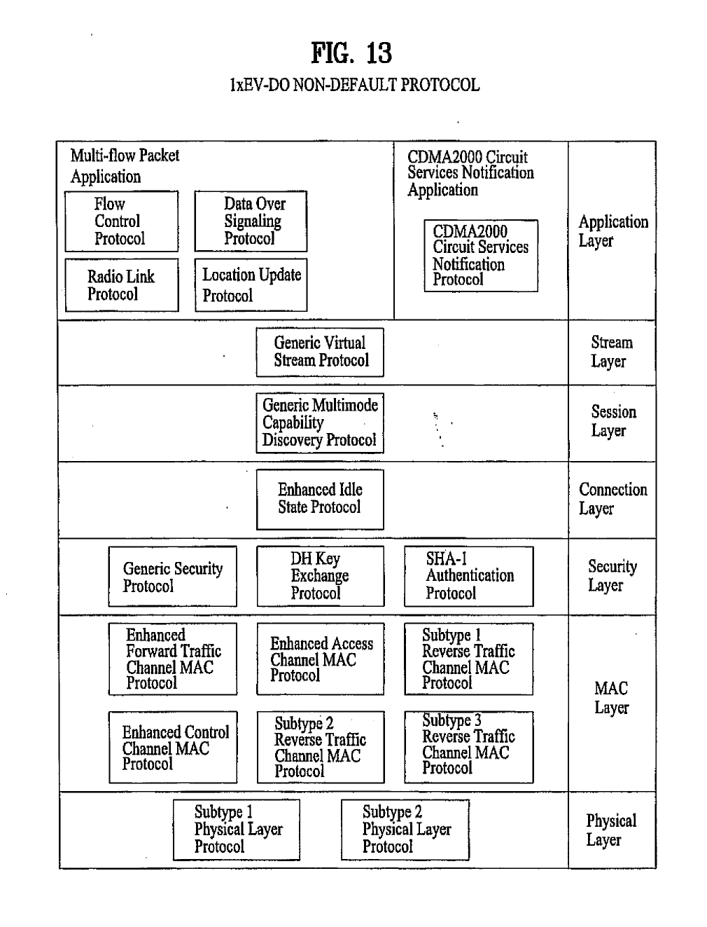

FIG. 12 illustrates a 1xEV-DO default protocol architecture. FIG. 13 illustrates a 1xEV-DO non-default protocol architecture.

Information related to a session in a 1xEV-DO system includes a set of protocols used by an MS 2, or access terminal (AT), and a BS 6, or access network (AN), over an airlink, a Unicast Access Terminal Identifier (UATI), configuration of the protocols used by the AT and AN over the airlink and an estimate of the current AT location.

The Application Layer provides best effort, whereby the message is sent once, and reliable delivery, whereby the message can be retransmitted one or more times. The stream layer provides the ability to multiplex up to 4 (default) or 255 (non-default) application streams for one AT 2.

The Session Layer ensures the session is still valid and manages closing of session, specifies procedures for the initial UATI assignment, maintains AT addresses and negotiates/provisions the protocols used during the session and the configuration parameters for these protocols.

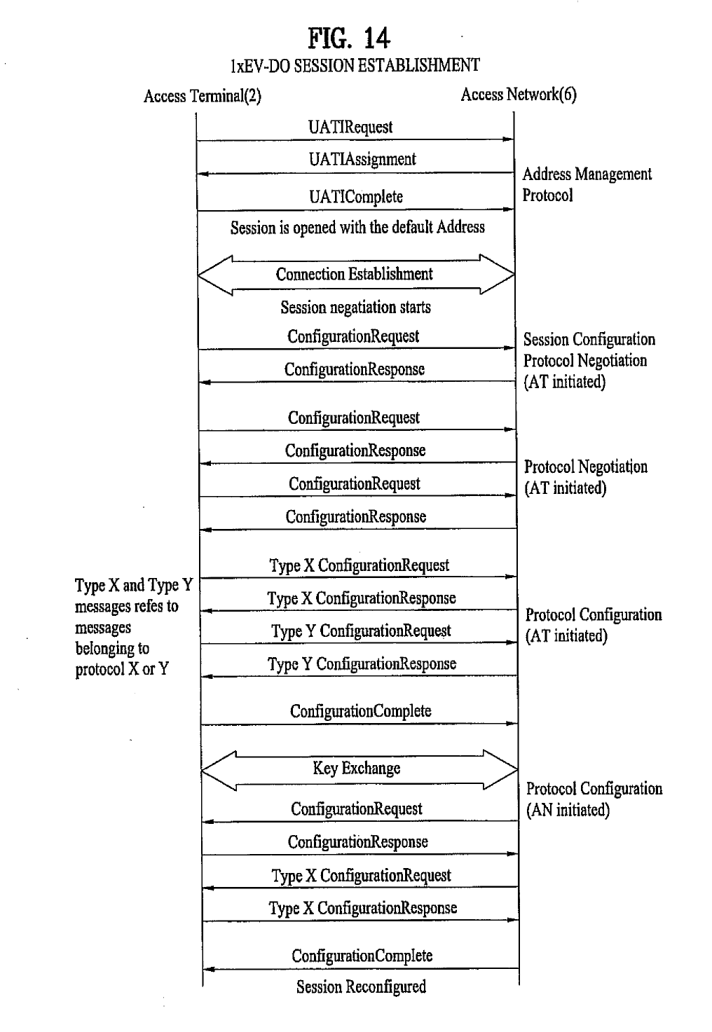

FIG. 14 illustrates the establishment of a 1xEV-DO session. As illustrated in FIG. 14, establishing a session includes address configuration, connection establishment, session configuration and exchange keys.

Address configuration refers to an Address Management protocol assigning a UATI and Subnet mask. Connection establishment refers to Connection Layer Protocols setting up a radio link. Session configuration refers to a Session Configuration Protocol configuring all protocols. Exchange key refers a Key Exchange protocol in the Security Layer setting up keys for authentication.

A “session” refers to the logical communication link between the AT 2 and the RNC, which remains open for hours, with a default of 54 hours. A session lasts until the PPP session is active as well. Session information is controlled and maintained by the RNC in the AN 6.

When a connection is opened, the AT 2 can be assigned the forward traffic channel and is assigned a reverse traffic channel and reverse power control channel. Multiple connections may occur during single session.

The Connection Layer manages initial acquisition of the network and communications. Furthermore, the Connection Layer maintains an approximate AT 2 location and manages a radio link between the AT 2 and the AN 6. Moreover, the Connection Layer performs supervision, prioritizes and encapsulates transmitted data received from the Session Layer, forwards the prioritized data to the Security Layer and decapsulates data received from the Security Layer and forwards it to the Session Layer.

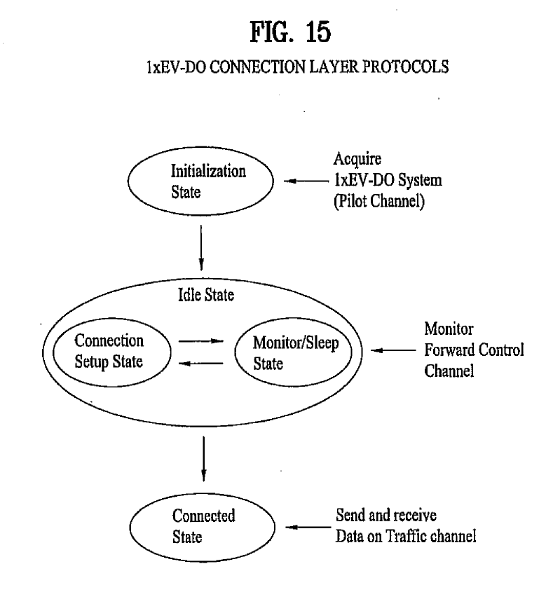

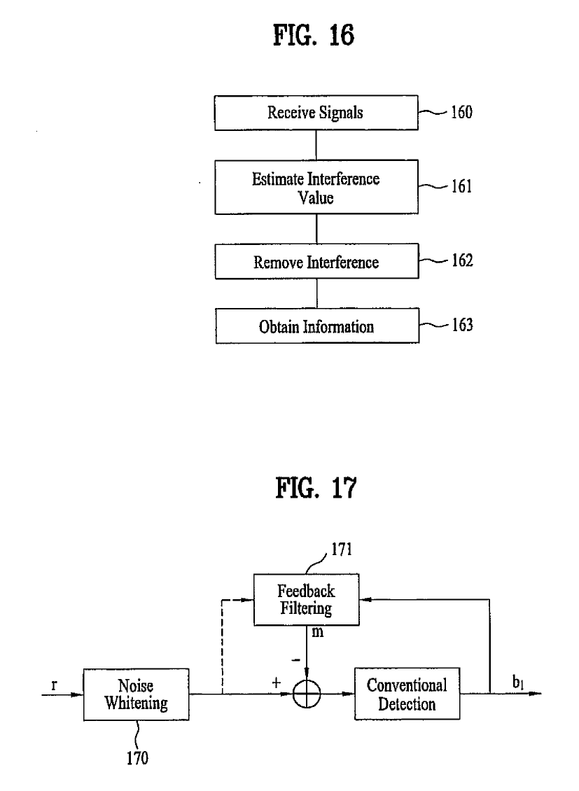

FIG. 15 illustrates Connection Layer Protocols. As illustrated in FIG. 16, the protocols include an Initialization State, an Idle State and a Connected State.

In the Initialization State, the AT 2 acquires the AN 6 and activates the initialization State Protocol. In the Idle State, a closed connection is initiated and the Idle State Protocol is activated. In the Connected State, an open connection is initiated and the Connected State Protocol is activated.

A closed connection refers to a state where the AT 2 is not assigned any dedicated air-link resources and communications between the AT and AN 6 are conducted over the access channel and the control channel. An open connection refers to a state where the AT 2 can be assigned the forward traffic channel, is assigned a reverse power control channel and a reverse traffic channel and communication between the AT 2 and AN 6 is conducted over these assigned channels as well as over the control channel.

The Initialization State Protocol performs actions associated with acquiring an AN 6. The Idle State Protocol performs actions associated with an AT 2 that has acquired an AN 6, but does not have an open connection, such as keeping track of the AT location using a Route Update Protocol. The Connected State Protocol performs actions associated with an AT 2 that has an open connection, such as managing the radio link between the AT and AN 6 and managing the procedures leading to a closed connection. The Route Update Protocol performs actions associated with keeping track of the AT 2 location and maintaining the radio link between the AT and AN 6. The Overhead Message Protocol broadcasts essential parameters, such as QuickConfig, SectorParameters and AccessParameters message, over the control channel. The Packet Consolidation Protocol consolidates and prioritizes packets for transmission as a function of their assigned priority and the target channel as well as providing packet de-multiplexing on the receiver.

The Security Layer includes a key exchange function, authentication function and encryption function. The key exchange function provides the procedures followed by the AN 2 and AT 6 for authenticating traffic. The authentication function provides the procedures followed by the AN 2 and AT 6 to exchange security keys for authentication and encryption. The encryption function provides the procedures followed by the AN 2 and AT 6 for encrypting traffic.

The 1xEV-DO forward Link is characterized in that no power control and no soft handoff is supported. The AN 6 transmits at constant power and the AT 2 requests variable rates on the forward Link. Because different users may transmit at different times in TDM, it is difficult to implement diversity transmission from different BS's 6 that are intended for a single user.

In the MAC Layer, two types of messages originated from higher layers are transported across the physical layer, specifically a User data message and a signaling message. Two protocols are used to process the two types of messages, specifically a forward traffic channel MAC Protocol for the User data message and a control channel MAC Protocol, for the signaling message.

The Physical Layer is characterized by a spreading rate of 1.2288 Mcps, a frame consisting of 16 slots and 26.67 ms, with a slot of 1.67 ms and 2048 chips. The forward Link channel includes a pilot channel, a forward traffic channel or control channel and a MAC channel.

The pilot channel is similar to the to the cdma2000 pilot channel in that it comprises all “0” information bits and Walsh-spreading with W0 with 192 chips for a slot.

The forward traffic channel is characterized by a data rate that varies from 38.4 kbps to 2.4576 Mbps or from 4.8 kbps to 3.072 Mbps. Physical Layer packets can be transmitted in 1 to 16 slots and the transmit slots use 4-slot interlacing when more than one slot is allocated. If ACK is received on the reverse Link ACK channel before all of the allocated slots have been transmitted, the remaining slots shall not be transmitted.

The control channel is similar to the sync channel and paging channel in cdma2000. The control channel is characterized by a period of 256 slots or 427.52 ms, a Physical Layer packet length of 1024 bits or 128, 256, 512 and 1024 bits and a data rate of 38.4 kbps or 76.8 kbps or 19.2 kbps, 38.4 kbps or 76.8 kbps.

The 1xEV-DO reverse link is characterized in that the AN 6 can power control the reverse Link by using reverse power control and more than one AN can receive the AT's 2 transmission via soft handoff Furthermore, there is no TDM on the reverse Link, which is channelized by Walsh code using a long PN code.

An access channel is used by the AT 2 to initiate communication with the AN 6 or to respond to an AT directed message. Access channels include a pilot channel and a data channel.

An AT 2 sends a series of access probes on the access channel until a response is received from the AN 6 or a timer expires. An access probe includes a preamble and one or more access channel Physical Layer packets. The basic data rate of the access channel is 9.6 kbps, with higher data rates of 19.2 kbps and 38.4 kbps available.

When more that one AT 2 is paged using the same Control channel packet, Access Probes may be transmitted at the same time and packet collisions are possible. The problem can be more serious when the ATs 2 are co-located, are in a group call or have similar propagation delays.

One reason for the potential of collision is the inefficiency of the current persistence test in conventional methods. Because an AT 2 may require a short connection setup time, a paged AT may transmit access probes at the same time as another paged AT when a persistence test is utilized.

Conventional methods that use a persistence test are not sufficient since each AT 2 that requires a short connection setup times and/or is part of a group call may have the same persistence value, typically set to 0. If AT's 2 are co-located, such as In a group call, the Access Probes arrive at the An 6 at the same time, thereby resulting in access collisions and increased connection setup time.

Therefore, there is a need for a more efficient approach for access probe transmission from co-located mobile terminals requiring short connection times. The present invention addresses this and other needs such as interference cancellation.

Interference cancellation (IC) is a strategy for forming an estimate of various interferences, such as interference symbol interference (ISI), co-channel interference (CCI), adjacent channel interference (ACI), and other possible multiple access interferences (MAI), and subtracting it from received signals before detection. Compared to other detection strategies, interference cancellation focuses more on interference estimation and different interference estimation methods may lead to different interference cancellation schemes (e.g., successive cancellation, multistage detection, and decision feedback interference cancellation (DFIC)). The DFIC, which includes minimum mean squared error (MMSE) decision-feedback detection and decorrelating decision-feedback detection, is the decision-driven detection scheme that combines several features of successive interference cancellation and multi-stage detection.

In a single-user decision-feedback equalization (DFE), previous decision outputs are fed back for estimating ISI and detecting the next symbol. Here, DFE is known to have the complexity close to linear equalization while its performance is close to maximum likelihood equalization,

In multi-user DFIC, both current and previous received signals and decision outputs are utilized for detecting desired users' information. The multi-user DFIC can be further defined by a conventional DFIC and a blind DFIC.

In conventional DFIC, other user's current decision outputs are used for detecting desired information providing all user's signal signatures are known. In blind DFIC, only received signals and detection outputs of the desired user(s) are used for separating signal subspaces and/or adapting receiver for better interference estimation. Here, signal subspaces can also be construed as a collection of certain desired signals.

The problem with existing DFIC approaches is that neither subspace separation nor receiver adapting procedure is simple and fast enough for fast-fading channels.

To address this problem, an alternative blind DFIC framework can be implemented. Here, the alternative blind DFIC requires a small amount of previously received signals for estimating interference and detecting desired signals. The difference from the conventional DFIC and the blind DFIC is that a minimum number of previously received symbols are utilized in addition to desired user(s)' signatures and timing. Instead of using them for signal signature estimation or signal subspace separation, previously received signals are directly taken as signal space bases for interference estimation. In addition, the proposed framework can be implemented using adaptive and iterative designs so that its complexity and detection delay can be further reduced. The alternative blind DFIC framework can be applied for asynchronous CDMA.

In detail, a conventional single-cell forward link (FL) DS/CDMA is used to discuss possible problems. There are K number of active users in a cell and data (i.e , bₖ where k=1, 2, . . . , K) are individually spread using different spreading sequences and synchronously transmitted to these users through multi-path channel corrupted additive white Gaussian noise (AWGN) with variance σ². The user k's RAKE output r(t) is sampled at

$${f}_{s} = \frac{1}{{T}_{s}}$$

and can be written by as shown in Equation 1.

$$\begin{matrix}r = {[ r ( n T + {T}_{s} + {τ}_{1} ) … r ( n T + L {T}_{s} + {τ}_{1} ) ]}^{T} \\ = {\sum }_{k = 1}^{K} {A}_{k} {B}_{k} {s}_{k} + n \\ = S A b + n\end{matrix} \qquad [ Equation 1 ]$$

In Equation 1, S=[s₁ s₂ . . . sₖ] is the received signal signature matrix including possible ISI and MAI information. Further, A=diag([A₁ A₂ . . . Aₖ]) is the amplitude diagonal matrix of the amplitudes{Aₖ: k=1, 2, . . . K}. In addition, b=[b₁ b₂ . . . bₖ]^{T} and L=T/Tₛ is the number of sample per symbol, which usually is not less than the spreading gain L_{c}. Because of MAI existing in the received signal r(t), the performance of conventional matched filter receiver suffers from the so-called near-far problem. Interference cancellation is one of the receiver techniques for solving this problem.

Blind Decision-Feedback Interference Cancellation

Without loss of the generality, the signal for the first G desired users can be detected or estimated here with S₁=[s₁ s₂ . . . s_{G}], which is known beforehand. Before this, the previously received M and the detected signal vectors can be assembled into Equation 2.
S[r[n−1]r[n−2] . . . r[n−M]=SAB+N=S₁A₁B₁+S₂A₂B₂+N [Equation 2]

In Equation 2, {r[n−m]: 1≦m≦M} denotes previously received and detected M signal, B=[B₁^{H}B₂^{H}] is the data matrix for S, S₂ is the original interfering signals' signatures, A₁, A₂, B₁, and B₂ are the amplitudes matrices and data matrices for desired users and interfering users, respectively, and N is a AWGN matrix. The minimum number of received signals a receiver requires for clearly identifying the K−G interfering users is M=K−G with rank of B₂ r (B₂)=K−G. With equation 2, interference subspace can be approximated by S̅₁ [symbol] span {sₘ|m=G+1, . . . K}≈span {S−S₁A₁B₁}. Further, the MAI m can be rewritten according to Equation 3.
mS₂A₂B₂=(S−S₁A₁B₁−N)B₂⁺b₂=S f−S₁D₁f+ñ [Equation 3]

In Equation 3, f [symbol] B₂⁺b2 denotes a projection of m onto the interfering subspace of S₂A₂B₂, D₁=A₁B₁, and n [symbol] N B₂⁺. Further, this equation shows that m can be estimated provided that f is known. In order to estimate f, QR-decomposition on S₁ can be performed, the result of which is shown by Equation 4.
S₁=Q₁R₁=Q₁₁R₁₁ [Equation 4]

Here, Q₁=[Q₁₁Q₁₂]∈R^{LxL} is orthogonal and R₁ =[R₁₁^{H}O^{H}]^{H}∈R^{LxL}. To Equation 4, Q₁₂^{H} can be applied to derive at Equation 5.
Q₁₂^{H}m=Q₁₂^{H}Sf+Q₁₂^{H}ñ [Equation 5]

Using Equation 5, f can be estimated. More specifically, since Q₁₂^{H}r=Q₁₂^{H}m+Q₁₂^{H}n, f can be estimated from Q₁₂^{H}r=Q₁₂^{H}S f+Q₁₂^{H}ñ. Here, ñ [symbol] ñ+n.

After f is estimated, m can be estimated using Equation 3 and extracted from r so that the desired information vector b₁ as well as A₁ can be detected and estimated from Equation 6.
S₁d₁≈r−(S−S₁\hat{D}₁)\hat{f} [Equation 6]

In Equation 6, d₁=A₁ b₁, \hat{D}₁ denotes previous detection outputs from S, and \hat{f}denotes an estimate of f. This can be done using either Viterbi algorithm or other sub-optimal detection schemes, This can be shown in FIG. 16.

FIG. 16 illustrates a flow diagram of a decision feedback interference cancellation process. In FIG. 16, a plurality of signals are received from one or more transmitting ends (S160). The received signals are noise whitened. Thereafter, the noise-whitened signals are processed in conjunction with estimated interference signal which is based on previous and current signal (S161). Here, the interference value can be estimated using a predetermined number of symbols or signals from the received signals and a previously determined interference value. Here, the predetermined number of the received signals and the current signal can be either fixed or updated through estimation. Moreover, the predetermined number can be a variable, or put differently, can be adjusted based on number of received signals. Thereafter the estimated interference value can be used to remove interference from the received signals (S162). Lastly, the desired information can be obtained after the interference is removed (S163).

The received signals as described above relate to baseband signals which are down-converted from intermediate or high frequency band and processed by at least one RAKE receiver or at least one equalizer, such as a least-squared (LS) equalizer, a minimum mean-squared errors (MMSE) equalizer, and a recursive least squared (RES) equalizer. Further, the received signal includes at least one desired and at least one non-desired signal, if available, treated as interfering signals. The desired signal is a function of known signal signatures which are either predetermined or previously estimated. Lastly, the signal signatures are user codes or distorted user codes caused by channel imperfection, for example.

FIG. 17 is an exemplary diagram illustrating decision feedback interference cancellation. As shown in FIG. 17, a noise-whitening unit 170 can be used to convert noise from the received signals from at least one transmitting end to white noise. A feedback filtering unit 171 can then be used to estimate interference value based on a predetermined number of symbols of the received signals and previously determined interference value. A removing unit can be used to remove interference from the received signal by using the estimated interference value. Lastly, an acquisition unit can be used to obtain desired information from the interference-removed received signal.

Since the previous decision outputs \hat{D}₁ are used for estimating m and A₁ and detecting b₁, this framework is named blind decision-feedback interference cancellation. Furthermore, this framework is not limited to a two-stage approach as shown above, but can also be implemented in a joint detection fashion with simultaneously estimating d₁ and f.

A. Least Squares Interference Cancellation

In traditional least squares estimations, the observation matrix is assumed to be error-free and all estimation errors are supposed to come from r. This can be formulated by the equation as shown in Equation 7.

$$[ \begin{matrix}{d}_{1 LS} \\ {f}_{LS}\end{matrix} ] = arg {min}_{x} {‖ r - G x ‖}_{2} \qquad [ Equation 7 ]$$

In Equation 7, G=[S₁(S−S₁D₁)], and based on this, d₁ as well as f can be estimated using the following equation.

$$[ \begin{matrix}{d}_{1 LS} \\ {f}_{LS}\end{matrix} ] = G + r \qquad [ Equation 8 ]$$

Besides the traditional LS assumption, another one is to assume both G and r are noise-polluted so that Equation 7 becomes the following total least squares (TLS) problem, as shown in Equation 9

$$[ \begin{matrix}{G}_{TLS} \\ [ \begin{matrix}{d}_{1 TLS} \\ {f}_{TLS}\end{matrix} ]\end{matrix} ] = arg {min}_{Y , x} {‖ [ \begin{matrix}G \\ r\end{matrix} ] - [ \begin{matrix}Y \\ {Y}_{x}\end{matrix} ] ‖}_{2} \qquad [ Equation 9 ]$$

Let G=U′Σ′V′^{T} and [G r]=UΣV^{T} be the SVD of G and [G r], respectively. If σ′_{K}>σ_{K+1}, the TLS estimation of d₁ and f can be expressed according to the following equation.

$$[ \begin{matrix}{d}_{1 TLS} \\ {f}_{TLS}\end{matrix} ] = {( {G}^{T} G - {σ}_{K + 1}^{2} I )}^{- 1} {G}^{T} r \qquad [ Equation 10 ]$$

Here, neither Equation 7 nor Equation 9 is accurate since S₁ is known to be noise-free and S is noise-corrupted. As such, it can be more reasonable to require S₁ to be unperturbed while keeping S estimated. Therefore, a mixed least squares (MLS) interference cancellation problem can be expressed by Equation 11.

$$[ \begin{matrix}{S}_{MLS} \\ {[ \begin{matrix}{d}_{1} + {D}_{1} f \\ f\end{matrix} ]}_{MLS}\end{matrix} ] = arg {min}_{Z , y} {‖ [ \begin{matrix}S \\ r\end{matrix} ] - [ \begin{matrix}Z \\ [ {S}_{1} Z ]\end{matrix} ] ‖}_{2} \qquad [ Equation 11 ]$$

If σ′_{K-G}>σ_{K-G+1}, the MLS estimation of f is f_{MLS}=(S ^{H}Q₁₂Q₁₂^{H}S−σ_{K-G÷1}I)⁻¹ S ^{H}Q₁₂Q₁₂^{H}S r. Here, σ′_{K-G and σ}_{K-G+1} are the (K−G)th and (K−G+1)th largest singular value of Q₁₂^{H}S and Q₁₂^{H} [r−S]. Further, MLS-IC d_{1MLS} can be expressed by the following equation.
d_{1MLS}=S₁⁺r−S₁⁺(S−S₁D₁)f_{MLS} [Equation 12]
B. Maximum Likelihood Interference Cancellation

In maximum likelihood interference cancellation (ML-IC), d₁ estimated with maximizing the probability density function (PDF) p(r; d₁, f). A ML estimator asymptotically is the minimum variance unbiased (MVU) estimator through it is not optimal in general. For the linear Gaussian signal model in Equation 6, ML-IC can be written by the following equation.

$$[ \begin{matrix}{d}_{1 ML} \\ {f}_{ML}\end{matrix} ] = arg {min}_{x} \{ {δ}^{H} - {R}_{\overline{n}} δ \} \qquad [ Equation 13 ]$$

In Equation 13, the estimator error vector δ=r−Gx. Therefore, the ML estimation of d₁ can be given according to Equation 14.

$${[ \begin{matrix}{d}_{1 ML} \\ {f}_{ML}\end{matrix} ] = {G}^{H} {R}_{\overline{n}} G )}^{- 1} {G}^{H} {R}_{\overline{n}}^{- 1} r \qquad [ Equation 14 ]$$

C. Mini. Mean-Square Error Interference Cancellation

With MMSE criterion, d₁ is estimated with minimizing the Bayesian mean squared error (BMSE), where the BMSE can be represented according to the following equation.

$${e}_{BMSE} = E {‖ [ \begin{matrix}{\hat{d}}_{1} \\ \hat{f}\end{matrix} ] - [ \begin{matrix}{d}_{1} \\ f\end{matrix} ] ‖}_{2}^{2} \qquad [ Equation 15 ]$$

The MMSE estimation can then be written by the following Equation 16.

$$[ \begin{matrix}{d}_{1 MMSE} \\ {f}_{MMSE}\end{matrix} ] = arg {min}_{x} E {‖ r - Gx ‖}_{2} \qquad [ Equation 16 ]$$

Further, if r, d₁, and f are jointly Gaussian, it can be solved by the following equation.

$$[ \begin{matrix}{d}_{1 MMSE} \\ {f}_{MMSE}\end{matrix} ] = {( {R}_{x} + {G}^{H} {R}_{\overline{n}} G )}^{- 1} {G}^{H} {R}_{\overline{n}}^{- 1} r , \\ where \\ {R}_{x} = E \{ [ \begin{matrix}{d}_{1} {d}_{1}^{H} & {d}_{1} {f}^{H} \\ {fd}_{1}^{H} & {ff}^{H}\end{matrix} ] \qquad [ Equation 17 ]$$

Implementation Issues

A. Adaptive Detection

When transmitted signals experience channel condition changes, it is better for the receiver to respond fast enough to follow this change with minimum adaptive lag. Using Equations 2 and 6, the proposed DFIC framework M previously received symbols for the next detection so that is may be able to track channel fast. Since its implementations typically involve the inverse G_{H}G in Equation 8, G^{H}R_{ñ}G in Equation 14, for example, one of the possible approaches is to follow Sherman-Morrison-Woodbury matrix inverse lemma.

For example, the following equation can be defined according to Equation 18.
Φ[n]=G^{H}[n]G[n] [Equation 18]

In Equation 18, G[n] denotes the instance of G at t=n, where Φ[n+1] can be written by Φ[n+1]=Φ[n]+u[n]u^{H}[n]. Alternatively, the inverse of Φ[n+1] can be recursively calculated by the following equation.

$${Φ}^{- 1} [ n + 1 ] = {Φ}^{- 1} [ n ] - \frac{{Φ}^{- 1} [ n ] u [ n ] {u}^{H} [ n ] {Φ}^{- 1} [ n ]}{1 + {u}^{H} [ n ] {Φ}^{- 1} [ n ] u [ n ]} \qquad [ Equation 19 ]$$

B. Iterative Detection

The presented detection framework can be generalized by solving the following optimization problem as shown in Equation 20.
\hat{d}₁=min ƒ(r;S,\hat{D}₁) [Equation 20]

Here, Equation 20 can be subject to possible constraints where the ƒ(·) is the objective function. Iterative detection is one of the approaches for solving this optimization problem. To this end, Equation 20 can be represented as shown in Equation 21.
\hat{d}₁=min ƒ(r;[S r],[\hat{D}₁\hat{d}₁]) [Equation 2]

Alternatively, another iterative framework for solving Equation 21 can be represented by Equation 22.

$$\hat{{d}_{1}} [ n + 1 ] = min f ( r ; [ \begin{matrix}S & r\end{matrix} ] , [ \begin{matrix}\hat{{D}_{1}} & \hat{{d}_{1} [ n ]}\end{matrix} ] ) ) \qquad [ Equation 22 ]$$

In practice, an IC detector can cancel the interfering signal provided that the decision was correct and channel information is known. Otherwise, it may increase the contribution of the interferers. In other words, the previous detection results of D₁ are critical here, and therefore, some coding/decoding schemes may be applied by detecting D₁ before the next detection.

The comparison between the proposed framework and other major schemes is organized in Table 1. The proposed framework only requires M, where L≧M≧(K−G), previous received signal for signal detection and its complexity is closed to conventional detectors while other blind approaches typically requires more than L signals.

TABLE 1

| | Conv. | Blind | Subspace | Blind |
|---|---|---|---|---|
| Parameters | DF-IC | MMSE | Approaches | DF-IC |
| Signature of desired user(s) | □ | □ | □ | □ |
| Signature of other users | □ | | | |
| Timing of desired user(s) | □ | □ | □ | □ |
| Timing of other users | □ | | | |
| Received amplitudes | □ | | | |
| ECC decoding-integratable | | | | |
| Initialization * | | ≧L | ≧L | M |
| Latency | K | 1 | 1 | 1 |
| Complexity order | K | 1 | 1 | 1 |

In Table 1, ‘*’ refers to blind MMSE or subspace approaches. More specifically, the blind MMSE or subspace approaches typically require more than L signals before their first detection.

With respect to a noise enhancement issue in LS-based decorrelating detection, the output signal-to-noise ratio (SNR) for user k is decreased by [Rₛ⁺]ₖₖ for the conventional decorrelating detection. Due to the noise item N in S, there is an additional noise enhancement in the proposed LS-DFIC.

Following Girko's Law, providing

$$α = \frac{K - G}{M}$$

is fixed, the diagonal element of

$$\frac{1}{M} ( {B}_{2}^{+} {b}_{2} ) {( {B}_{2}^{+} {b}_{2} )}^{H}$$

can be approximated to be 1−α with K,M→α. Therefore, the covariance matrix of ñ can be expressed by Equation 23.

$${R}_{ll}^{\sim} = \frac{1 M + K - G}{M} {σ}^{2} 1 \qquad [ Equation 23 ]$$

Since

$$\frac{1 M + K - G}{M} {σ}^{2} > {σ}^{2} ,$$

the receiver output noise is enhanced.

A commonly used performance measure for a multiuser detector is asymptotic multiuser efficiency (AME) and Near-Far Resistance (NFR). The AME of the proposed schemes is represented in Equation 24.

$${\overline{η}}_{k} = {\frac{M}{2 M + G - K} [ {R}_{s}^{+} ]}_{kk}^{- 1} \qquad [ Equation 24 ]$$

The Cramer-Rao Lower Bound (CRLB) is given by the inverse of the Fisher information matrix (FIM). Provided that S and D₁ are known, the parameter vector φ=[ σ̅²d₁^{T}f^{T}]^{T} is defined in which

$${\overline{σ}}^{2} = ( 1 + \frac{M}{M + G - K} ) {σ}^{2} ,$$

for computing the FIM. The FIM can be represented by Equation 25.

$$I ( ϕ ) = E \{ ( \frac{\partial ln L}{\partial ϕ} ) {( \frac{\partial ln L}{\partial ϕ} )}^{T} \} \qquad [ Equation 25 ]$$

In Equation 25, In L is the log-likelihood function given by

$$ln L = C - L ln {\overline{σ}}^{2} - \frac{1}{2 {\overline{σ}}^{2}} {‖ ⅇ ‖}_{2}^{2} ,$$

where C is constant and e=r−S₁d₁+(S−S₁D₁)f. Provided that S and D1 are known, the close-form CRLB expression of d1 is then given by the following equation.

$$CRLB ( x \text{\vert} S , {D}_{1} ) = ( 1 + \frac{M}{M + G - K} ) {{σ}^{2} ( {G}^{H} G )}^{+} \qquad [ Equation 26 ]$$

In Equation 26, x=[d₁^{T} f^{T}]^{T}.

As discussed, the blind interference cancellation framework is simple and direct while requiring a minimum amount of previous detected symbols.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of mitigating interference in a wireless communication system, the method comprising:
receiving at least two signals from a plurality of transmitting ends;
estimating interference value based on a predetermined number of the received signals and a current signal;
removing interference from the received signals using the estimated interference value; and
obtaining desired information from the interference-removed received signal.

2. The method of claim 1, wherein the predetermined number of the received signals and the current signal is either fixed or updated through estimation.

3. The method of claim 1, wherein the predetermined number is a variable number.

4. The method of claim 1, wherein the received signals relate to baseband signals which are down-converted from intermediate or high frequency band and processed by at least one RAKE receiver or at least one equalizer.

5. The method of claim 4, wherein the at least one equalizer include a least-squared (LS) equalizer, a minimum mean-squared errors (MMSE) equalizer, and a recursive least squared (RLS) equalizer.

6. The method of claim 1, wherein the received signals include at least one desired and at least one non-desired signal, if available, treated as interfering signals.

7. The method of claim 6, wherein the desired signal is a function of known signal signatures which are either predetermined or previously estimated.

8. The method of claim 7, wherein the signal signatures are user codes or distorted user codes.

9. The method of claim 1, wherein the received signals are synchronously, asynchronously, or mixedly received.

10. The method of claim 1, wherein the received signal is represented by a special signal signature matrix, S.

11. The method of claim 10, wherein the special signal signature matrix, S further includes a known signature, s_{g}, where 1≦g≦G, and previously received signals, rₘ, where 1≦m≦(M−G).

12. The method of claim 11, wherein g denotes user index, G denotes a number of users in the current signal, m denotes a previously received signal index, and M denotes a maximum number of previously determined number of signals.

13. The method of claim 12, wherein any one of a number of G and M is a variable number.

14. A receiver system for mitigating interference, the system comprising:
a noise whitening unit for converting noise of at least one received signal to a white noise;
a feedback filtering unit for estimating interference value based on a predetermined number of the received signals and a current signal;
a removing unit for removing interference of a received signal using the estimated interference value; and
acquisition unit for obtaining desired information from the interference-removed received signal.

15. The system of claim 14, wherein the at least one received signal inputted into the noise whitening unit originate from at least one source.

16. The system of claim 14, wherein the received signals include at least one desired and at least one non-desired signal, if available, treated as interfering signals.

17. The system of claim 16, wherein the desired signal is a function of known signal signatures which are either predetermined or previously estimated.

18. The system of claim 17, wherein the signal signatures are user codes or distorted user codes.

19. The method of claim 14, wherein the received signal is represented by a special signal signature matrix, S, which is defined by a known signature, s_{g}, where 1≦g≦G, and previously received signals, rₘ, where 1≦m≦(M−G).

20. The method of claim 19, wherein g denotes user index, G denotes a number of users in the current signal, m denotes a previously received signal index, and M denotes a maximum number of previously determined number of signals, and wherein any one of a number of G and M is a variable number.
